(19) United States
(12) Patent Application Publication
(10) Pub. No.: US 2002/0068146 A1
(43) Pub. Date: Jun. 6, 2002

(54) Lamellar strip

(76) Inventor: Alfred Steinl, Altdorf (DE)

Correspondence Address: Pitney, Hardin, Kipp & Szuch LLP, 711 Third Avenue, New York, NY, 10017, US

(21) Appl. No.: 09/871,480

(22) Filed: May 31, 2001

(30) Foreign Application Priority Data
Jul. 10, 2000 (DE) 100 33 454.7

(51) Int. Cl. B32B 3/10; B32B 27/14

(52) U.S. Cl. 428/131; 428/198; 428/156

(57) ABSTRACT

A strip comprising a plurality of lamellae that are interconnected via a first connecting element, each lamella having two opposing lamella legs and at least two recesses extending transversely to the longitudinal axis of the strip, at least one second connecting element being formed between the recesses.

The present invention relates to a lamellar strip consisting of a plurality of successive lamellae. The invention moreover relates to a profile which is made of such a lamellar strip and is preferably U- or V-shaped. The invention further relates to a device for producing such a lamellar strip and the respective skeleton strip and a respective production method.

Lamellar strips that are used as reinforcing inserts for profiled fitting strips having a U- or V-shaped cross-section and made of rubber or plastics are known.

The present invention is based on the object to provide an improved strip consisting of lamellae as well as a skeleton strip made thereof, a device and a method for producing such a strip as well as the respective skeleton strip.

This object is achieved with the features of the claims. The invention and the preferred embodiments of the invention, which are mentioned in the dependent claims, have the particular advantage of combining low weight and at the same time improved mechanical properties, such as higher stability and resistance to fracture. A profile, e.g. a U-shaped profile, that is provided as a reinforcing insert with a skeleton strip made of the strip according to the present invention, has a high clamping power. According to experiments, haul-off values are achieved that correspond to current specifications, i.e. when testing a profile that is inserted into a mounting, the force required for pulling the profile out of the mounting is essentially increased. The present invention in particular permits the use of extremely thin steel strips which have the same clamping power as conventional strips but a lower weight. The weight reduction is most of all due to the provided recesses and cutouts. As an alternative, the present invention permits the use of aluminium which provides for similarly high clamping powers when the strip thickness is respectively increased while weight can be saved on account of the lower specific weight of aluminium. A preferred embodiment of the present invention consists in a connecting element arranged in the area of each lamella and preferably shaped as an inclined web. The inclination of this web increases the tensile strength of the strip and simultaneously allows for a compression of the strip, thus facilitating the processing of a profile made of this strip. The inclination of the web is variable depending on the desired properties; a larger angle with respect to the longitudinal axis of the strip leads in this connection to an increased compressing capability and vice versa. According to the present invention, the recesses provided in each lamella leg and/or the cut-outs provided between the longitudinally adjacent lamella legs are designed such that each lamella leg preferably tapers towards the edges. Preferably, the cut-outs between adjacent lamella legs have the shape of narrow gaps with parallel walls. The strip according to the invention may simply and very precisely be manufactured from a metal strip using a punching die. It is particularly suited for being subsequently processed into a skeleton strip and for the subsequent production of a profile. Tests have shown that the profile according to the present invention has an appealing outer surface from an optical point of view with only shallow dimples in the area of the cavities, i.e. the recesses and cut-outs, and/or are quite inconspicuous.

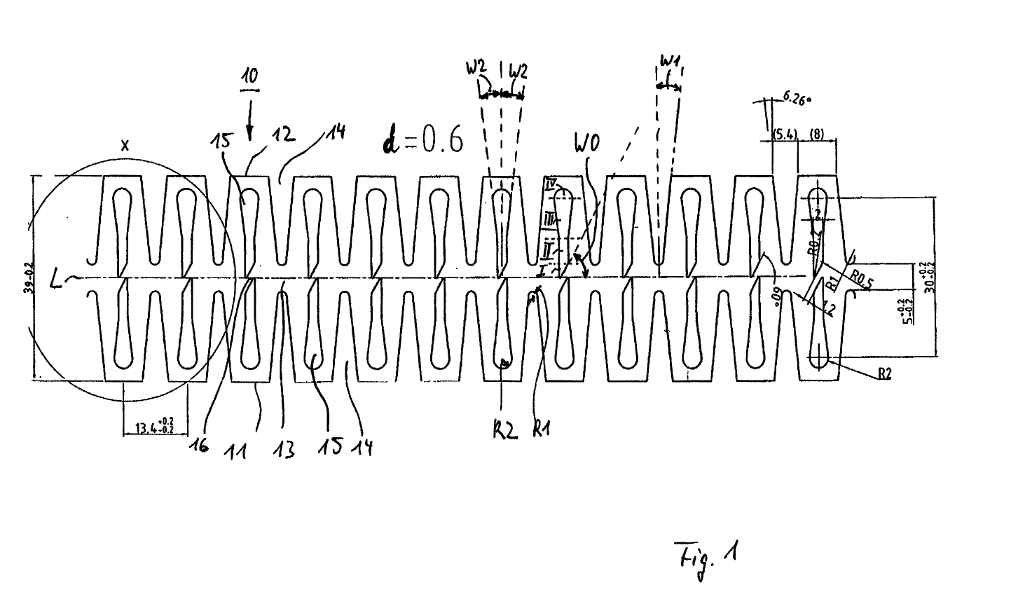

The invention will be illustrated in the following in more detail by means of FIGS. 1 to 3, in which

FIG. 1 shows a top view of a first embodiment of the invention;

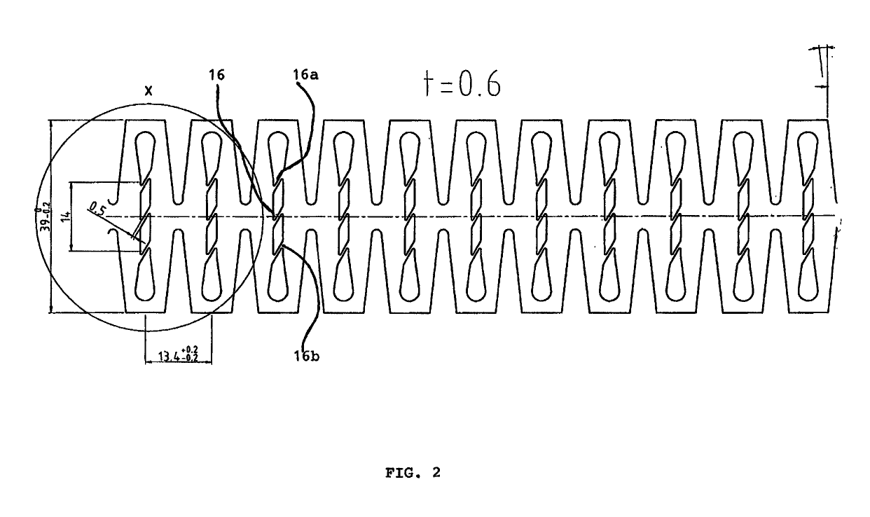

FIG. 2 shows a top view of a second embodiment of the invention;

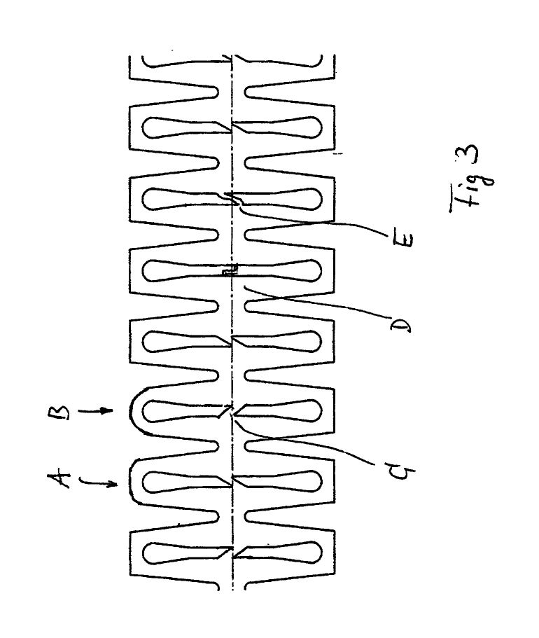

FIG. 3 shows alternative embodiments of the invention; and

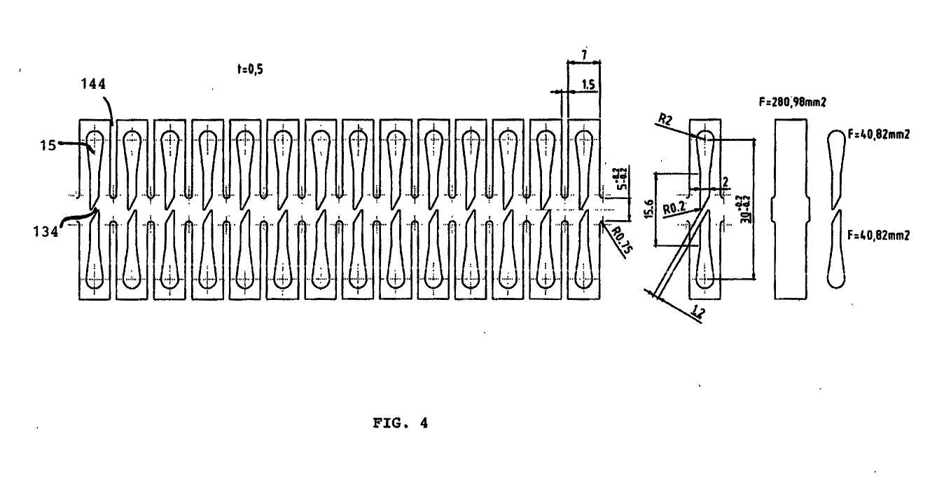

FIG. 4 shows a third embodiment of the invention.

The lamellar strip shown in FIG. 1 consists of a plurality of lamellae 10 adjacent in the direction of the longitudinal axis. The lamellar strip has a longitudinal axis L, which is shown in form of a dot-dash line. Each lamella 10 is provided with two legs 11, 12 opposing each other. Adjacent lamellae 10 are connected via a first connecting element 13 in form of a material bridge. V-shaped cut-outs 14 are provided between longitudinally adjacent lamella legs 11 or lamella legs 12. A recess 15 is provided in the area of each lamella leg. In the preferred embodiment of the invention shown in FIG. 1, an inclined second connecting element 16 is provided in the area of the longitudinal axis. Each recess 15 may be subdivided into four sections I to IV. The first section I has the form of a triangle extending from the longitudinal axis towards the edge of the strip, one side of the triangle being essentially perpendicular to the longitudinal axis and the other side of the triangle forming an angle W0. The second section II is essentially strip-like with parallel sides extending essentially perpendicular to the longitudinal axis. The third section III adjoins the second section II and widens towards the edge. This enlargement is symmetrical with respect to the perpendicular to the longitudinal axis, an angle W2 being enclosed between the side and the perpendicular.

The fourth section IV of the recess 15 is semicircular in the embodiment as depicted and adjoins the third section III.

The opposing recesses 15 of the two lamella legs 11, 12 are essentially mirror-symmetrical with respect to the longitudinal axis L, the first section I being mirror-inverted with respect to the perpendicular to the longitudinal axis L. This results in the inclined web 16.

The cut-outs 14 are on both sides symmetrical to the longitudinal axis and end in the area of the first connecting element 13 with a radius R1.

The dimensioning shown in FIG. 1 refers to an aluminium strip having a thickness of 0.6 mm and a width of 39 mm. Deviations of individual values indicated here as well as a proportional increase or decrease are within the scope of the invention; specific reference is, however, made to the ranges indicated in the claims.

FIG. 2 shows a second embodiment of the invention which comprises three second connecting elements 16, 16a and 16b. In detail, in the area of the longitudinal axis an inclined second connecting element 16 is provided, as in the first embodiment. Each side of this connecting element 16 is provided with a further second connecting element 16a or 16b. As shown, each further second connecting element is provided in the second section II. All second connecting elements preferably have the same size and parallel inclinations. As to the remaining features, reference is made to the above description of the first embodiment.

FIG. 3 shows details A to E which may be realized individually or in combination in the first and second embodiments as mentioned above.

Detail A exemplarily shows each edge of each lamella leg being rounded at the corners.

Detail B exemplarily shows the edge of each lamella leg with the shape of an arc of a circle.

Detail C shows an arrangement of a connecting web extending mirror-symmetrical with respect to the perpendicular to the longitudinal axis as compared with the orientation of the adjacent webs.

Detail D shows a second connecting element being Z-shaped. This shape permits the provision of lamella strip with higher strength in the pulling direction.

Detail E shows a second connecting element being S-shaped.

All the aforementioned details are exemplarily shown in FIG. 3, modifications and optional combinations being within the scope of the invention. Several different second connecting elements may likewise be provided. Element F in FIG. 3 has three connecting elements 16, 16a and 16b. Connecting element 16, which is positioned in the middle, points in a direction that encloses an angle W0ₘ with respect to the longitudinal axis and the two outer connecting elements 16a and 16b, which are spaced apart and arranged on both sides, point in a direction that encloses an angle W0ₐ with respect to the longitudinal axis. The connecting elements 16, 16a and 16b may have every shape shown in detail C, D or E, however, the outer connecting elements 16a and 16b having preferably the same shape.

A profile made of a lamella strip may be further processed after extrusion-coating with plastics or rubber. The lamella strip within the profile can, for example, be subjected to such a mechanical stress that individual or several of the second connecting elements break. In an embodiment according to detail D of FIG. 3, the second connecting element could break in the area of the two corners of the Z-shaped course. This is advantageous in that the profile may be compressed and extended more easily and, for example in the construction of vehicles, may be adapted to the given dimensions of a vehicle door.

The advantage of the third embodiment shown in FIG. 4 consists in that the cut-outs have the shape of narrow gaps 144 with parallel sides. The gaps 144 are arranged at both sides of each first connecting element 134 symmetrically to the longitudinal axis of the lamella strip. For further details, reference is made to the above description in particular in combination with FIG. 1. The gap is semicircular in the area of the first connecting element. In the shown example, the gap ends at the height of the fourth section IV at the border to the third section III of recess 15.

In the processing of a U-profile, this embodiment has the advantage that the course of the radius forms a harmonic line and that the formation of bevels is prevented.

The aforementioned embodiments may optionally be combined, thus resulting in different forms having the respective properties for desired applications.

1. A strip having a plurality of lamellae which are interconnected via a first connecting element, each lamella comprising two opposing lamella legs and having at least two recesses extending transversely to the longitudinal axis of the strip, at least one second connecting element being formed between the recesses.

2. The strip according to claim 1, wherein the second connecting element allows the strip to be compressed and/or extended towards the longitudinal axis of the strip.

3. The strip according to claim 1 or 2, wherein the second connecting element is a connecting web that is inclined by an angle W1 with respect to the longitudinal axis of the strip, the angle W0 being preferably in a range of 10° to 80°, more preferably in a range of 30° to 70°, even more preferably in a range of 50° to 65° and most preferably 60°.

4. The strip according to any of claims 1 to 3, wherein the second connecting element is in the area of the longitudinal axis of the strip and has preferably the same shape in each lamella, and wherein it is particularly preferred that the second connecting elements of all lamellae have the same orientation.

5. The strip according to any of claims 1 to 4, wherein at least one cut-out extending from the edge of the strip to the first connecting element is arranged between two lamellae adjacent in the longitudinal axis of the strip.

6. The strip according to any of claims 1 to 5, wherein the first connecting element is in the area of the longitudinal axis of the strip and one cut-out is arranged preferably symmetrically to and on both sides of the longitudinal axis in the transverse direction, which cut-out preferably forms a gap with parallel walls, the width of the gap being preferably 1/10 to 1/20 of the length of the gap.

7. The strip according to claim 5 or 6, wherein each cut-out is V-shaped and widens from the first connecting element towards the edge.

8. The strip according to claim 7, wherein each cut-out is symmetrical with respect to the perpendicular to the longitudinal axis and has an aperture angle W1 that is preferably within the range of 2° to 30°, more preferably within the range of 3° to 15°, even more preferably within the range of 4° to 10° and most preferably 6°.

9. The strip according to any of claims 5 to 8, wherein each cut-out is rounded in the area of the first connecting element and preferably forms an arc of a circle having a radius R1, the radius R1 being preferably in the range of 0.2 to 1.5 mm, more preferably in the range of 0.4 to 1 mm and most preferably 0,5 mm.

10. The strip according to any of claims 1 to 9, wherein the respective recesses in the opposing lamella legs are mirror-inverted with respect to the perpendicular to the longitudinal axis of the strip.

11. The strip according to claims 1 to 10, wherein each recess is provided with at least one first section and one adjoining second section, the first section preferably expanding from the longitudinal axis of the strip towards the second section.

12. The strip according to claim 11, wherein the first section of the recess is triangular and has a first side essentially extending towards the perpendicular to the longitudinal axis and a second side extending at an angle W0 with respect to the perpendicular, said angle being preferably in the range of 10° to 80°, more preferably in the range of 30° to 70°, even more preferably in the range of 50° to 65° and most preferably 60°.

13. The strip according to claim 12, wherein the second section is strip-like with sides that are parallel to the perpendicular to the longitudinal axis and preferably a third section that widens towards the edge of the strip adjoins the second strip.

14. The strip according to claim 13, wherein the third section is V-shaped and is preferably symmetrical with the perpendicular to the longitudinal axis and encloses an angle W2 which is preferably in the range of 2° to 30°, more preferably in the range of 3° to 15°, even more preferably in the range of 4° to 10° and most preferably 6°.

15. The strip according to any of claims 11 to 14, wherein the recess is provided with a fourth section and said section is spaced apart from the edge of the strip and rounded, and preferably semicircular with a radius R2 that is preferably in the range of 0.5 to 5 mm, more preferably in the range of 1 to 3 mm and most preferably 2 mm.

16. The strip according to any of claims 1 to 15, wherein each lamella is provided with a straight edge and the corners are preferably rounded in the area of the transitions into the cut-out.

17. The strip according to any of claims 1 to 16, wherein each lamella has a width of 8 mm in the area of the edge and/or each cut-out has a width of 5,4 mm in the area of the edge and/or the strip has a width of 39 mm and/or the width of the first connecting element perpendicular to the longitudinal axis is 5 mm and/or the width of the recess is at least 2 mm and/or the width of the second connecting element in the direction of its extension is 1.2 mm, each of the aforementioned values being variable by ±50% and the aforementioned values being proportionally increasable and decreasable.

18. The strip according to any of claims 1 to 17, wherein the strip has a thickness d that is preferably in the range of 0.1 to 2 mm, more preferably 0.2 to 1 mm and most preferably 05. to 0.6 mm.

19. The strip according to any of claims 1 to 18, consisting of metal, preferably steel and more preferably of aluminium.

20. A skeleton strip having a U-shaped or V-shaped cross-section consisting of a strip according to any of claims 1 to 19, wherein said strip is respectively bent with respect to the longitudinal axis.

21. A profile comprising a skeleton strip according to claim 20 that is extrusion-coated with plastics or rubber.

22. A device for producing a strip according to any of claims 1 to 19, characterized by a respective punching die.

23. A method for producing a strip according to claims 1 to 19 comprising the steps of providing a strip which is preferably made of metal and punching of the described recesses.
